(19) United States
(12) Patent Application Publication
(10) Pub. No.: US 2008/0216337 A1
(43) Pub. Date: Sep. 11, 2008

(54) Tape rule having identifying pattern and mark dimensions

(76) Inventor: Michael Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/714,175

(22) Filed: Mar. 6, 2007

(51) Int. Cl. G01B 3/10

(52) U.S. Cl. 33/759

(57) ABSTRACT

A tape rule having identifying pattern and mark dimensions in which graduated measuring marks are printed on the front surface of the ruler blade. Furthermore, a hook is disposed on the end of the ruler blade to provide for pulling out the ruler blade when length measurements are taken by the user. The back surface of the ruler blade has identifying patterns, graduated lines, measurement unit numerals, and written explanation areas printed at a quantity of specific relative positions. The measurement positions of the graduated lines and the graduated measuring marks on the front surface are aligned and also respectively collocated with matching identifying patterns and written explanation areas, in which are printed simple character-based explanations. As such, the present invention is a tape rule structure that provides for rapid and accurate pattern indication and measurement position.

### BACKGROUND OF THE INVENTION

1) Field of the Invention

The invention herein relates to a tape rule having identifying pattern and mark dimensions in which graduated measuring marks are printed on the front surface of the ruler blade and, furthermore, a hook is disposed on the end of the ruler blade to provide for pulling out the ruler blade when length measurements are taken by the user. The back surface of the ruler blade has identifying patterns, graduated lines, measurement unit numerals, and written explanation areas printed at a quantity of specific relative positions. The graduated line measurement positions and the front surface graduated measuring marks are aligned and also collocated with matching identifying patterns and written explanation areas, in which are printed simple character-based explanations. As such, the present invention is a tape rule structure that provides for rapid and accurate pattern indication and measurement positioning.

2) Description of the Prior Art

Conventional tape rules, referring to FIG. 1, FIG. 2, and FIG. 3, typically consist of a construction-use or engineering-use tape rule 10 comprised of a housing 11, a lock button 12, a spiral spring (installed in the housing and not shown in the drawings), and a long narrow ruler blade 13, and printed on the long narrow ruler blade 13 are graduated measuring marks 15, wherein the spiral spring, as with similar springs, possesses wind-up elasticity that is utilized to produce extension and retraction, with the long narrow ruler blade 13 and the spiral spring both installed in the housing 11. Since the long narrow ruler blade 13 and the spiral spring are installed as an interactive assembly, the pulling out and return of the long narrow ruler blade 13 is a function of the corresponding action of the spiral spring. One end of the long narrow ruler blade 13 extends outside the housing 11 and, furthermore, and a hook 14 is disposed on the end of the long narrow ruler blade 13 to provide for the direct manual pulling out of the long narrow ruler blade 13 when length measurements are taken by the user; when pulled out a certain length, the user pushes the lock button 12, causing it to slide forward to produce an anchoring effect such that the long narrow ruler blade 13 is secured at a fixed length to facilitate measurement and recording, in which the user typically, the narrow ruler blade 13 now immobilized, views the graduated measuring mark 15 numerals printed on the surface of the long narrow ruler blade 13, which indicate length, to thereby obtain a measurement of accurate length. As shown in FIG. 3, typical of conventional ruler blades 13, the ruler blade back surface 16 is blank.

Conventional ruler blades 13 have graduated measuring mark numerals printed only on the upper layer along the surface of the ruler blade 13 and the back surface is usually left blank. The inventor of the invention herein, in view of the conventional tape rule ruler blade and its incapability to provide for practical functionality that still remains unenhanced, conducted research and effected improvements which culminated in the development of a tape rule having identifying patterns and mark dimensions to thereby remedy the shortcomings of the conventional product.

### SUMMARY OF THE INVENTION

The primary objective of the invention herein is to provide a tape rule having identifying patterns and mark dimensions, wherein graduated measuring marks are printed on the front surface of the ruler blade and, furthermore, a hook is disposed on the end of the ruler blade to provide for pulling out the ruler blade when length measurements are taken by the user, and wherein the back surface of the ruler blade has identifying patterns, graduated lines, measurement unit numerals, and written explanation areas printed at a quantity of specific relative positions; the graduated line measurement positions and the front surface graduated measuring marks are aligned and also collocated with matching identifying patterns and written explanation areas, in which are printed simple character-based explanations, thereby comprising a tape rule structure that provides for rapid and accurate pattern indication and measurement positioning.

To enable the examination committee a further understanding of the unique features and advantages of the present invention, the brief description of the drawings below are followed by the detailed description of the preferred embodiments.

### Application Modes

The invention herein is a tape rule having identifying patterns and mark dimensions, wherein graduated measuring marks are printed on the front surface of the ruler blade, the unique features of which include: The back surface of the ruler blade has identifying patterns, graduated lines, measurement unit numerals, and written explanation areas printed at a quantity of specific relative positions, thereby providing the user rapid and accurate pattern indication and measurement positioning.

The invention herein is capable of the indoor measurement of objects such as that in household electrical appliance industry, interior design field, furniture industry, and other various industries. Based on the product dimensions utilized by these various industries, the back surface of the said tape rule ruler blade can have identifying patterns and mark dimensions printed at a quantity of specific relative positions.

The invention herein is capable of the outdoor measurement of objects such as that in the construction engineering industry, sports grounds business, road and transportation industry, and other related industries. Based on the product dimensions utilized by these various industries, the back surface of the said tape rule ruler blade can have identifying patterns and mark dimensions printed at a quantity of specific relative positions.

The invention herein is capable of being designed to meet application requirements, wherein the back surface of the said tape rule ruler blade has custom designed identifying patterns and mark dimensions printed at a quantity of specific relative positions.

As its structure was described above, the invention herein is capable of the claimed utilization and performance. However, the said description only relates to the most preferred embodiment of the invention herein and is intended to disclose its unique features, which shall not be construed as a limitation on the rights entitled the present invention. As such, all modifications, such as changes in the color of the graduated marks and adaptations of the pattern indications, shall remain within the scope of claims belonging to the invention herein.

In summation of the foregoing section, since the invention herein is capable of achieving the claimed objectives and applications, possesses exceptional practical value, and, furthermore, an identical or similar product has not been disclosed in the market, the invention herein is submitted to the examination committee for review and the granting of the commensuration patent rights.

### BRIEF DESCRIPTION OF THE DRAWINGS

FIG. 1 is an isometric drawing of a conventional tape rule 10 structure.

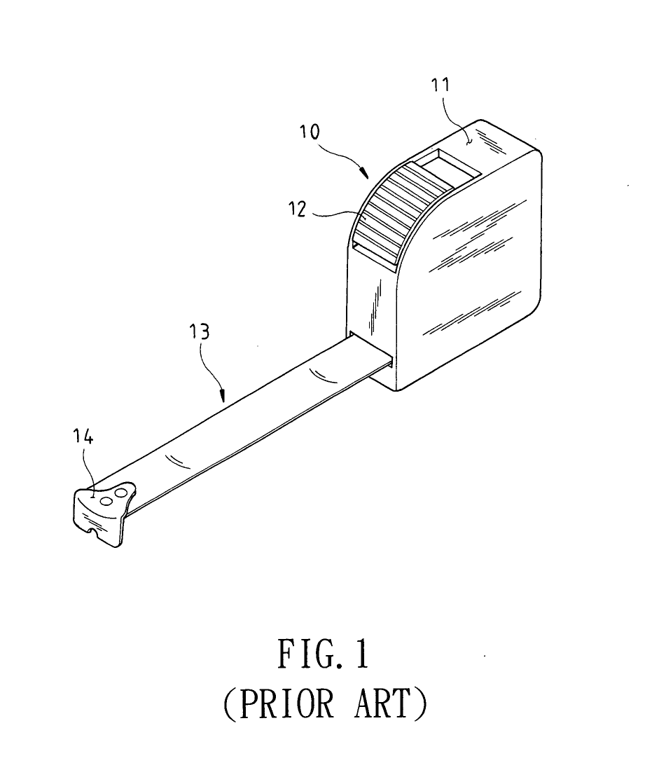

FIG. 2 is an orthographic drawing of the front surface of a conventional tape rule blade 13.

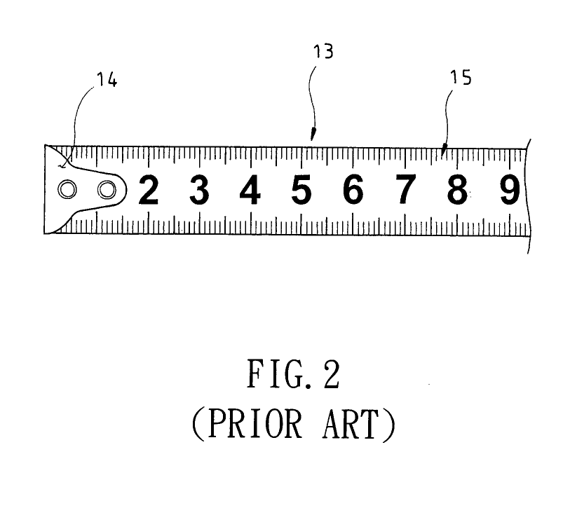

FIG. 3 is an orthographic drawing of the back surface of a conventional tape rule blade 13.

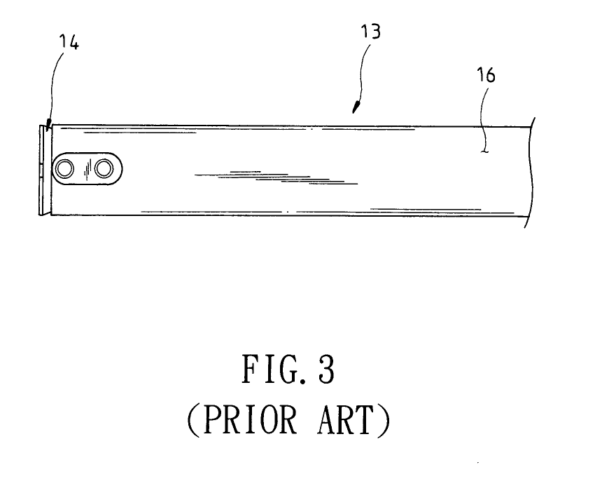

FIG. 4 is an orthographic drawing of the front surface of the ruler blade 20 of the invention herein.

FIG. 5 is an orthographic drawing of the back surface of the ruler blade 20 of the invention herein.

FIG. 6 is an orthographic drawing of another front surface embodiment of the ruler blade 20 of the invention herein.

FIG. 7 is an orthographic drawing of another back surface embodiment of the ruler blade 20 of the invention herein.

### DETAILED DESCRIPTION OF THE PREFERRED EMBODIMENTS

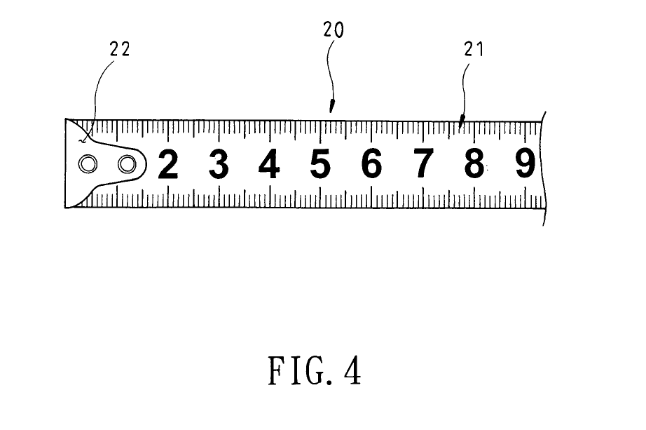

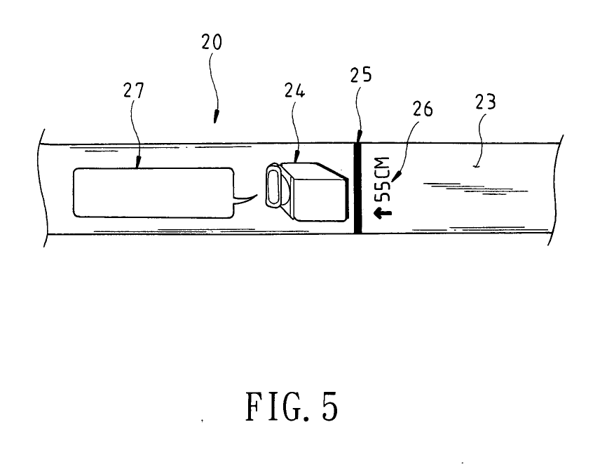

Referring to FIG. 4 and FIG. 5, the present invention is a tape rule having identifying patterns and mark dimensions, wherein graduated measuring marks 21 are printed on the front surface of the tape ruler blade 20, the said graduated measuring marks 21 may consist of internationally used metric or English system graduated units, with metric system graduated units indicated in FIG. 4; a hook 22 is disposed on the end of the ruler blade 20 to provide for the direct manual pulling out of the ruler blade 20 when length measurements are taken by the user. As indicated in FIG. 5, the back surface 23 of the ruler blade 20 of the invention herein has identifying patterns 24, graduated lines 25, measurement unit numerals 26, and written explanation areas 27 printed at specific relative positions, the meaning so conveyed thereby is that the measurement position of the said measurement unit numerals 26, specifically the graduation 55 cm on the front surface of the ruler blade 20, is aligned with a washing machine graphic of the identifying pattern 24, indicating to manufacturers that the width or depth of the conventional washing machine depicted is 55 cm; and a matching written explanation area 27 for the printing therein of a simple character-based explanation, the said written explanation area 27 in the drawing is blank, but on the actual product, the content would be in the language of the country or region of product utilization, the options including Chinese, Japanese, German, and so on to provide for rapid and accurate pattern indication and measurement position.

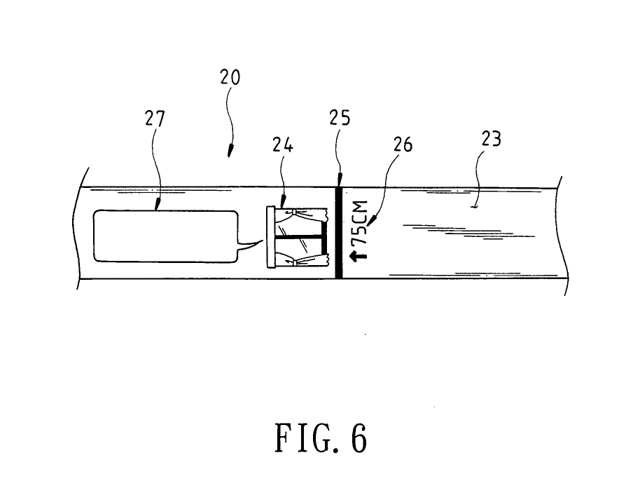

As shown in FIG. 6, the back surface 23 of the ruler blade 20 of the invention herein has an identifying pattern 24, graduated lines 25, measurement unit numerals 26, and a written explanation area 27 printed at specific relative positions, the meaning so conveyed thereby is that the measurement position of the said measurement unit numerals 26, specifically the graduation 75 cm on the front surface of the ruler blade 20, is aligned with a window graphic of the identifying pattern 24, indicating to manufacturers that the width of the conventional window depicted is 75 cm; and a matching written explanation area 27 for the printing therein of a simple character-based explanation, the said written explanation area 27 in the drawing is blank, but on the actual product, the content would be in the language of the country or region of product utilization, the options including Chinese, Japanese, German, and so on to provide for rapid and accurate pattern indication and measurement position.

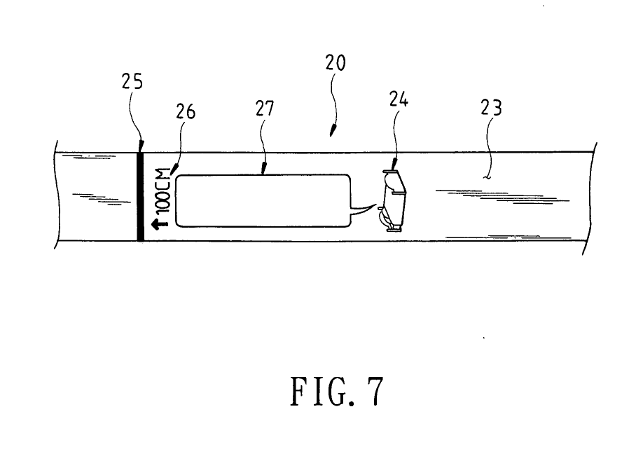

As shown in FIG. 7, the back surface 23 of the ruler blade 20 of the invention herein has an identifying pattern 24, graduated lines 25, measurement unit numerals 26, and a written explanation area 27 printed at specific relative positions, the meaning so conveyed thereby is that the measurement position of the said measurement unit numerals 26, specifically the graduation 100 cm on the front surface of the ruler blade 20, is aligned with a bed graphic of the identifying pattern 24, indicating to manufacturers that the width of the conventional bed depicted is 100 cm; and a matching written explanation area 27 for the printing therein of a simple character-based explanation, the said written explanation area 27 in the drawing is blank, but on the actual product, the content would be in the language of the country or region of product utilization, the options including Chinese, Japanese, German, and so on to provide for rapid and accurate pattern indication and measurement position.

What is claimed is:

1. A tape rule having identifying pattern and mark dimensions, wherein graduated measuring marks are printed on the front surface of the ruler blade and, furthermore, a hook is disposed on the end of the said ruler blade to provide for the direct manual pulling out of the said ruler blade when length measurements are taken by the user; the features are that the back surface of the said ruler blade of the invention herein has a quantity of identifying patterns, graduated lines, measurement unit numerals, and written explanation areas printed at specific relative positions.
